(19) United States
(12) Patent Application Publication
(10) Pub. No.: US 2013/0162051 A1
(43) Pub. Date: Jun. 27, 2013

(54) POWER TRANSMISSION APPARATUS, POWER RECEPTION APPARATUS AND POWER TRANSFER SYSTEM

(71) Applicants: Saori Michihata, Koganei-shi (JP); Kaoru Haruyama, Fujisawa-shi (JP); Hiromichi Suzuki, Hamura-shi (JP)

(72) Inventors: Saori Michihata, Koganei-shi (JP); Kaoru Haruyama, Fujisawa-shi (JP); Hiromichi Suzuki, Hamura-shi (JP)

(21) Appl. No.: 13/608,464

(22) Filed: Sep. 10, 2012

(30) Foreign Application Priority Data
Dec. 27, 2011 (JP) 2011-287006

(51) Int. Cl. H02J 17/00

(52) U.S. Cl. 307/104

(57) ABSTRACT

According to one embodiment, a power transfer system includes a power transmission apparatus and a power reception apparatus. The power transmission apparatus has a power transmission module, and a first wireless communication device configured to transmit physical profile information of the power transmission apparatus. The power reception apparatus has a power reception module, a second wireless communication device configured to receive the physical profile information, and a controller. Wireless power transfer is conducted between the power transmission module and the power reception module. The controller is configured to cross-check a physical profile of a power signal of the wireless power transfer received by the power reception module with the physical profile information and identify the first wireless communication device based on a result of the cross-check.

### CROSS-REFERENCE TO RELATED APPLICATION(S)

This application is based upon and claims the benefit of priority from Japanese Patent Application No. 2011-287006, filed Dec. 27, 2011; the entire contents of which are incorporated herein by reference.

### BACKGROUND

### Technical Field

Embodiments described herein relate generally to a power transmission apparatus, a power reception apparatus and a power transfer system.

### BRIEF DESCRIPTION OF THE DRAWINGS

FIG. 1 is an exemplary diagram showing an example of the configuration of a system including a power transmission apparatus and a power reception apparatus according to an first embodiment;

FIG. 2 is an exemplary view showing a model of the system according to the first embodiment;

FIG. 3 is an exemplary characteristic chart for explaining power transmission patterns in wireless power transfer according to the first embodiment;

FIG. 4 is an exemplary flow chart of the first embodiment;

FIG. 5 is an exemplary characteristic chart showing power transmission patterns in wireless power transfer for use in a second embodiment;

FIG. 6 is an exemplary flow chart of the second embodiment; and

FIG. 7 is an exemplary flow chart of a third embodiment.

### DETAILED DESCRIPTION

According to one embodiment, a power transfer system includes a power transmission apparatus and a power reception apparatus. The power transmission apparatus has a power transmission module, and a first wireless communication device configured to transmit physical profile information of the power transmission apparatus. The power reception apparatus has a power reception module, a second wireless communication device configured to receive the physical profile information, and a controller. Wireless power transfer is conducted between the power transmission module and the power reception module. The controller is configured to cross-check a physical profile of a power signal of the wireless power transfer received by the power reception module with the physical profile information and identify the first wireless communication device based on a result of the cross-check.

Hereinafter, various embodiments will be described hereinafter with reference to the accompanying drawings.

### First Embodiment

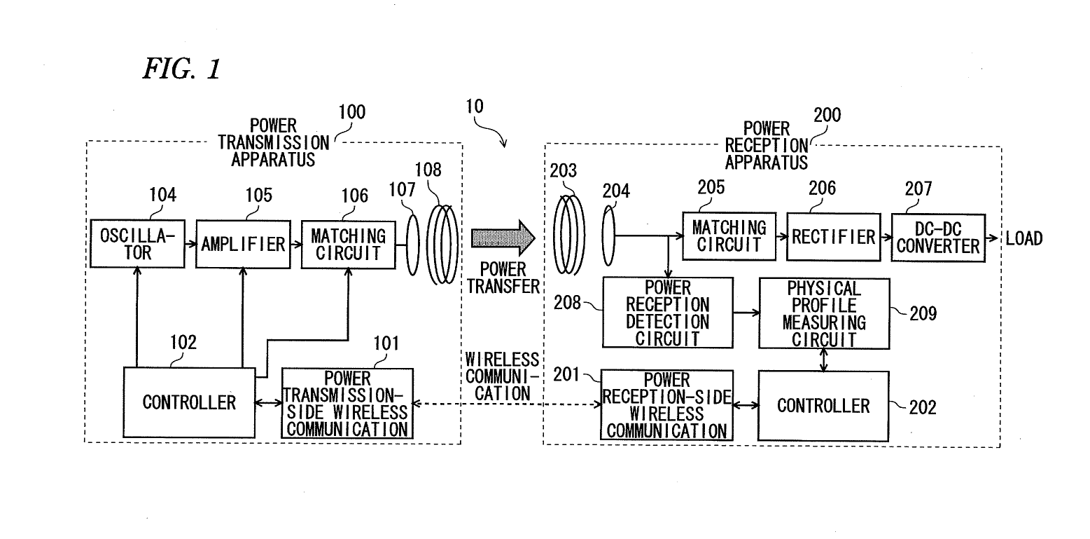

A first embodiment will be described with reference to FIGS. 1 to 4.

First, in wireless power transfer, AC magnetic flux is generally generated by a resonant coil provided in a power transmission apparatus for the wireless power transfer. The generated AC magnetic flux passes through a coil provided in a power reception apparatus to thereby generate an electromotive force on the power reception side. The generated electromotive force is converted into a desired voltage by DC-DC conversion so that the desired voltage is used. In this manner, the power transfer is performed. In addition, in a data communication module, communication is performed chiefly for the purpose of terminal authentication which is performed before the start of the power transfer, a grasp of requested power, etc. The resonant coils of the power transmission apparatus and the power reception apparatus improve the power transfer efficiency when the power transmission apparatus and the power reception apparatus are separate from each other. In accordance with a distance between the power transmission apparatus and the power reception apparatus, the number of resonant coils may be one, or three or more resonant coils may be used for a relay effect.

The first embodiment will be described below with reference to the drawings. First, FIG. 1 is an exemplary diagram showing an example of a form in which a wireless power transfer system 10 according to an example of the first embodiment is used. The wireless power transfer system 10 has a power transmission apparatus 100 etc., and a plurality of power reception apparatuses 200, etc. Although FIG. 1 shows the case where the number of power reception apparatuses is one, the number of power reception apparatuses is not limited thereto.

The power transmission apparatus 100 has an excitation portion 107, a resonance portion 108, etc. The power reception apparatus 200 has a resonance portion 203 and an excitation portion 204. The other constituent elements will be described later.

The excitation portion 107 of the power transmission apparatus 100 excites an AC current in the resonance portion 108 at a frequency f0. The resonance frequency of the resonance portion 108 is adjusted so as to be equal to that of the resonance portion 203 of the power reception apparatus 200. The power transmission apparatus 100 drives the resonance portion 108 with the resonance frequency so as to release magnetic energy. The power reception apparatus 200 or the like receives the magnetic energy so as to receive power by wireless.

Power transfer at the frequency f0 will be described here.

Both the resonance frequency (resonant frequency) of the resonance portion 108 in the power transmission apparatus 100 and the resonance frequency of the resonance portion 203 in the power reception apparatus 200 are adjusted to be f0. An AC current with the frequency f0 is introduced into the excitation portion 107 of the power transmission apparatus 100 so that the excitation portion 107 is driven to excite an AC current with the frequency f0 in the resonance portion 108. The resonance portion 108 resonates at the resonance frequency f0 of the resonance portion 108 to generate an AC magnetic field and release magnetic energy. In the power reception apparatus 200, the resonance portion 203 magnetically resonates at the frequency f0 in response to the AC magnetic field. Oscillating magnetic energy generated by the magnetic resonance of the resonance portion 203 is transmitted to the excitation portion 204 due to electromagnetic induction so that electric power is received by wireless by the power reception apparatus 200.

That is, since the resonance portion 108 of the power transmission apparatus 100 and the resonance portion 203 of the power reception apparatus 200 magnetically resonate with each other, an AC magnetic field is introduced to the power reception apparatus 200 side. The excitation portion 204 then catches power from the energy of the oscillating magnetic field with which the resonance portion 203 resonates. Thus, electric power can be transferred from the power transmission apparatus 100 to the power reception apparatus 200 by wireless.

Next, the example of the configuration of the power transfer system including the power transmission apparatus 100 and the power reception apparatus 200 will be described again with reference to FIG. 1.

The power transmission apparatus 100 has a controller 102, a communication module 101 (power transmission-side wireless communication), an oscillation portion 104 (for example, an oscillator), an amplification portion 105 (for example, an amplifier), a matching portion 106 (for example, a matching circuit), the excitation portion 107 (for example, an f0 excitation coil), the resonance portion 108 (for example, an f0 resonant coil), etc.

The communication module 101 receives a power request transmitted from the power reception apparatus 200. The power request includes information such as an apparatus identification code of the power reception apparatus, a resonance frequency with which the power reception apparatus is compatible, electric power requested by the power reception apparatus, etc. On receiving the power request, the communication module 101 outputs the request to the controller 102.

The controller 102 controls the respective constituent elements of the power transmission apparatus 100. For example, when the communication module 101 receives a power request from the power reception apparatus 200 or the like, the controller 102 determines an energy amount of magnetic energy to be released from the resonance portion 108, in accordance with the power request. The controller 102 gives the amplification portion 105 an instruction to amplify the AC current in accordance with the determined energy amount. In addition, the controller 102 gives an instruction to drive the oscillation portion 104.

The oscillation portion 104 generates an AC current with a predetermined frequency f0 and supplies the AC current to the amplification portion 105. The amplification portion 105 amplifies the signal intensity of the supplied AC current to a predetermined level in accordance with the instruction from the controller 102. On receiving the amplified AC current, the matching portion 106 matches the impedance of the signal with the excitation portion 107, the resonance portion 108, etc. which will be described later.

The excitation portion 107 is, for example, a loop antenna, a helical antenna, or the like. When the AC current with the frequency 10 is input to the excitation portion 107, the excitation portion 107 is driven to excite the resonance portion 108 disposed in the vicinity of the excitation portion 107 by means of the electromagnetic induction. Thus, an AC current is induced in the resonance portion 108. Incidentally, the excitation portion 107 excites the resonance portion 108 to induce the AC current with an intensity corresponding to the intensity of the AC current input from the matching portion 106.

The resonance portion 108 may be a coil or the like, which can resonate with magnetism at the predetermined frequency ID. The resonance frequency is determined based on the diameter of the coil, the number of turns of the coil, etc. When an AC current is input to the excitation portion 107, the resonance portion 108 induces an AC current with the frequency f0 by means of the electromagnetic induction between the excitation portion 107 and the resonance portion 108. Thus, the resonance portion 108 releases AC magnetic energy with the resonance frequency f0. The resonance portion 108 magnetically resonates (resonates) with the resonance portion 203 of the power reception apparatus 200 at the resonance frequency f0 so that the magnetic energy is transferred to the power reception apparatus 200 by wireless.

Next, the power reception apparatus 200 will be described. The power reception apparatus 200 has a controller 202, a communication portion 201 (power reception-side wireless communication), the resonance portion 203 (for example, an f0 resonant coil), the excitation portion 204 (for example, an ID excitation coil), a matching circuit 205, a rectification portion 206 (for example, a rectifier), a conversion portion 207 (for example, a DC-DC converter), etc. In addition, the power reception apparatus 200 has a power reception detection circuit 208 and a physical profile measuring circuit 209. The physical profile is configured to be sent out from a so-called sending-out portion (an example of a power transmission module) of the power transmission apparatus 100 including the oscillation portion 104, the amplification portion 105, the matching portion 106, the excitation portion 107 and the resonance portion 108.

The communication portion 201 transmits a power request for power transmission, to the power transmission apparatus 100 in accordance with an instruction from the controller 202. The power request mentioned herein includes information such as an apparatus identification code of the power reception apparatus 200, a magnetic resonance frequency at which the power reception apparatus 200 can resonate, electric power requested by the power reception apparatus 200, etc.

The controller 202 controls the respective constituent elements of the power reception apparatus 200. For example, the controller 202 gives the communication portion 201 an instruction to transmit a power request. In addition, the controller 202 also has a function of switching ON/OFF the power reception function of the power reception apparatus 200. That is, the controller 202, for example, gives a not-shown switch an instruction to cut off electric connection between the excitation portion 204 and a module in a subsequent stage to the excitation portion 204, so that the power reception function of the power reception apparatus can be stopped. On the contrary, in order to activate the power reception function, the controller 202 makes control to connect the excitation portion 204 to the module in the subsequent stage.

The resonance portion 203 may be a coil or the like, which can magnetically resonate with the resonance portion 108 of the power transmission apparatus 100 at the frequency f0. In the excitation portion 204, an AC current with the frequency f0 is induced by means of the electromagnetic induction with the magnetically resonating resonance portion 203. Thus, the AC current is input to the matching portion 205.

The matching portion 205 matches the impedance of the input AC current with the impedance of a module in the subsequent stage to the matching portion 205. The rectification portion 206 converts the input AC current to a DC current. The conversion portion 207 increases or decreases the voltage of the DC current input from the rectification portion 206, so as to convert the inconstant voltage to a constant voltage. The conversion portion 207 outputs the constant-voltage DC current to a load circuit consuming power.

That is, the resonance frequency of the resonance portion 203 provided in the power reception apparatus 200 corresponds to the resonance frequency f0 used by the power transmission apparatus 100 for transmission of power. The resonance frequency generally varies in accordance with each power reception apparatuses.

The resonance portions 108 and 203 resonating at the frequency f0 are set so that the resonance (resonant) Q (Quality) factor of the resonance portions 108 and 203 is a high Q factor. That is, for example, coils whose numbers of turns and/or diameters can secure a high resonance Q factor at the frequency f0 are used for the resonance portions 108 and 203. Thus, for example, when the resonance frequency is 20 MHz and the Q is 1,000, it is possible to obtain a high-efficiency characteristic with a narrow and sham bandwidth of −3 dB, which is 20 MHz/1000=20kHz.

In addition, the resonance portions 108 and 203 which can resonate at the frequency f0 can also resonate with multiplication waves of the frequency f0. However, the resonance portions 108 and 203 show a higher Q factor at the frequency f0 than a resonance Q factor at any other frequency (for example, frequencies of the multiplication waves).

The power transmission apparatus 100 and the power reception apparatus 200 may perform communication using the excitation portions and the resonance portions provided in the apparatuses respectively. On this occasion, a communication signal-transmitting side apparatus drives an excitation portion thereof with a communication signal. An AC magnetic field thus generated is caught by an excitation portion of a communication signal-receiving side apparatus. In this manner, the communication signal can be transferred by wireless. The communication signal, for example, has a bandwidth in which the communication signal is modulated around a central frequency which is the resonant frequency of the resonators used for transmitting and receiving the signal.

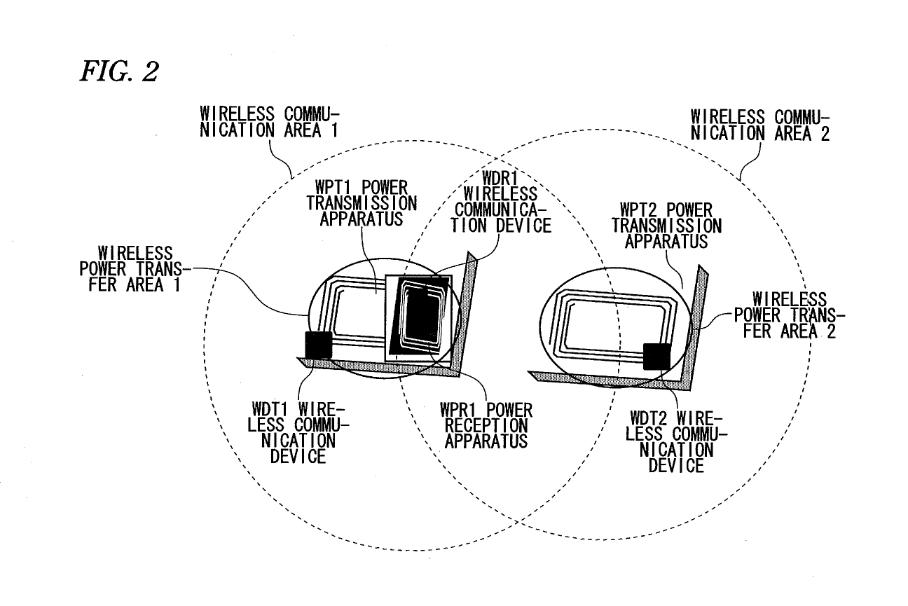

FIG. 2 exemplarily shows a model of the system according to the first embodiment. As shown in FIG. 2, wireless communication for data communication in the first embodiment is applied to a system using a different frequency band (therefore a wireless communication area is different from a wireless power transfer area) from that for wireless power transfer. In order to secure reliability in communication, transmission power of a communication signal is generally set to sufficiently cover an area where power transfer can be performed. As a result, the following case may occur easily. That is, when two power transmission apparatuses come close to each other, wireless communication areas of the power transmission apparatuses may partially overlap with each other, but wireless power transfer areas thereof do not overlap with each other so that wireless power transfer can be performed normally without occurrence of interference between one wireless power and another. In such circumferences, the following phenomenon may occur. A wireless communication device WDR1 provided in a power reception apparatus WPR1 for wireless power transfer can communicate with not only a wireless communication device WDT1 as a target with which the wireless communication device WDR1 has to communicate originally but also an adjacent wireless communication device WDT2. Therefore, it is not easy to uniquely determine the wireless communication device provided in a power transmission apparatus WPT1 which serves as a transmitter of power received by the power reception apparatus. In this case, according to the related art, if there are a plurality of wireless communication devices that the power reception apparatus can communicate with, the power reception apparatus starts communication with a wireless communication device which is selected at random, a wireless communication device with which the power reception apparatus communicated last time, or a wireless communication device from which a signal having the highest intensity is received. For the start of communication, a targeted wireless communication device is a wireless communication device provided in a power transmission apparatus for wireless power transfer whose wireless power transfer area covers a place where a power reception apparatus for wireless power transfer. However, if the wireless communication device of the power reception apparatus establishes connection to another wireless communication device than the targeted wireless communication device, information from a power transmission apparatus from which the power reception apparatus can receive power is not provided. Therefore, even if an authentication process or the like were completed and power transfer to the power reception apparatus were started, the power reception apparatus could not receive the power or the power reception apparatus would attempt to receive power assigned to another power reception apparatus. Since the power reception apparatus cannot obtain expected power, the power reception apparatus repeats a request to retransmit power. When a predetermined timeout period has passed, the power reception apparatus detects inconsistency between the wireless communication device and the power transmission apparatus. After that, the power reception apparatus establishes connection to a wireless communication device which has not been selected and moves to the procedure of authentication and power transfer again. The power reception apparatus attempts to establish connection to the targeted wireless communication device. Thus, in the related art, the power reception apparatus may establish connection to a wireless communication device which is located out of the wireless power transfer area so that it may take time to initiate power reception properly. Also, the power reception apparatus may disturb power supply assigned to another power reception apparatus. In the first embodiment, a physical profile of a power signal obtained by measurement in a power reception apparatus is cross-checked with information, obtained by wireless communication, about the physical profile of the power signal of the power transmission apparatus (hereinafter which may be referred to as “physical profile information”) so as to identify a targeted wireless communication device. Examples in the first embodiment will be described below for each of two different power transmission patterns. Here, power for a fixed period indicating a head of a power feed cycle is defined as beacon, power to be transferred to feed power to a power reception apparatus is defined as power feed portion, and a power portion obtained by combining the beacon and the power feed portion is defined as power burst. In addition, a group of information including values, which determine a power transmission pattern, such as a beacon length, a beacon cycle, a power burst length (which may be referred to as a burst length), a power feed portion length, a stop period length, a beacon amplitude, a power feed portion amplitude, a transfer frequency, a difference between the beacon amplitude and the power feed portion amplitude, a ratio between (i) the power burst length and (ii) a difference between the power burst length and the beacon cycle, a ratio between the power burst length and the stop period length, is defined as a physical profile. It is noted that the physical profile may not include all the values listed above, but may include one or some of the listed values.

### EXAMPLE 1

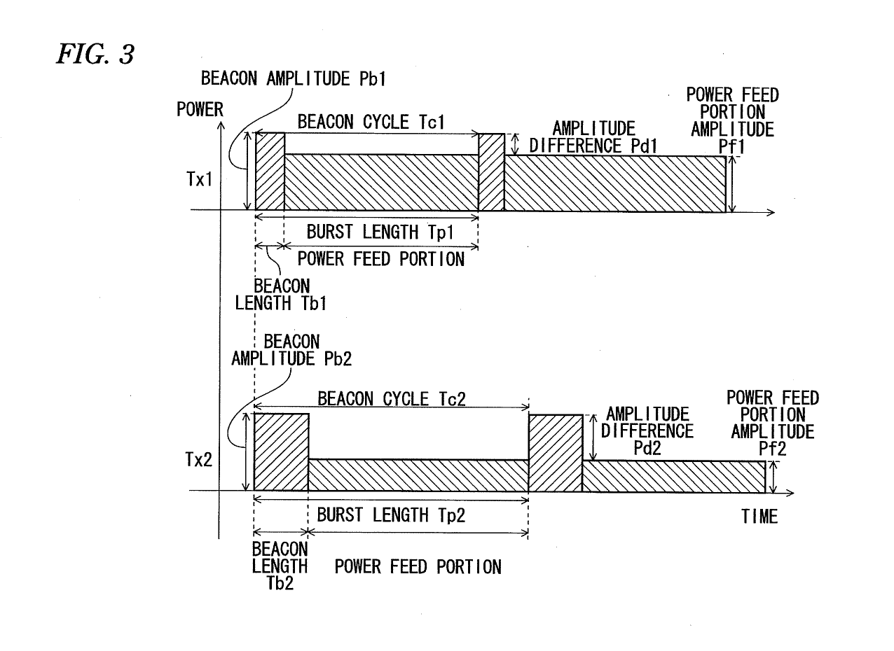

FIG. 3 exemplarily shows power transmission patterns in wireless power transfer. Power transmission in this system is continuous. In each power transmission pattern, the amplitude of the beacon (beacon amplitude Pbn) is larger than that of the power feed portion (power feed portion amplitude Pfn). It is assumed that that Tbn represents a beacon length of a power transmission apparatus Txn, Tpn represents a beacon cycle period of the power transmission apparatus Txn, Tpn represents a burst length of the power transmission apparatus Txn, Pdn represents an amplitude difference between the beacon and the power feed portion of the power transmission apparatus Txn (that is, Pdn=Pbn−Pfn), and Fn represents a transmission frequency of the power transmission apparatus Txn. These values may be fixed values or may be different from one cycle to another. In order to distinguish a plurality of power transmission apparatuses, it is assumed that the plurality of power transmission apparatuses are different in at least one of the values.

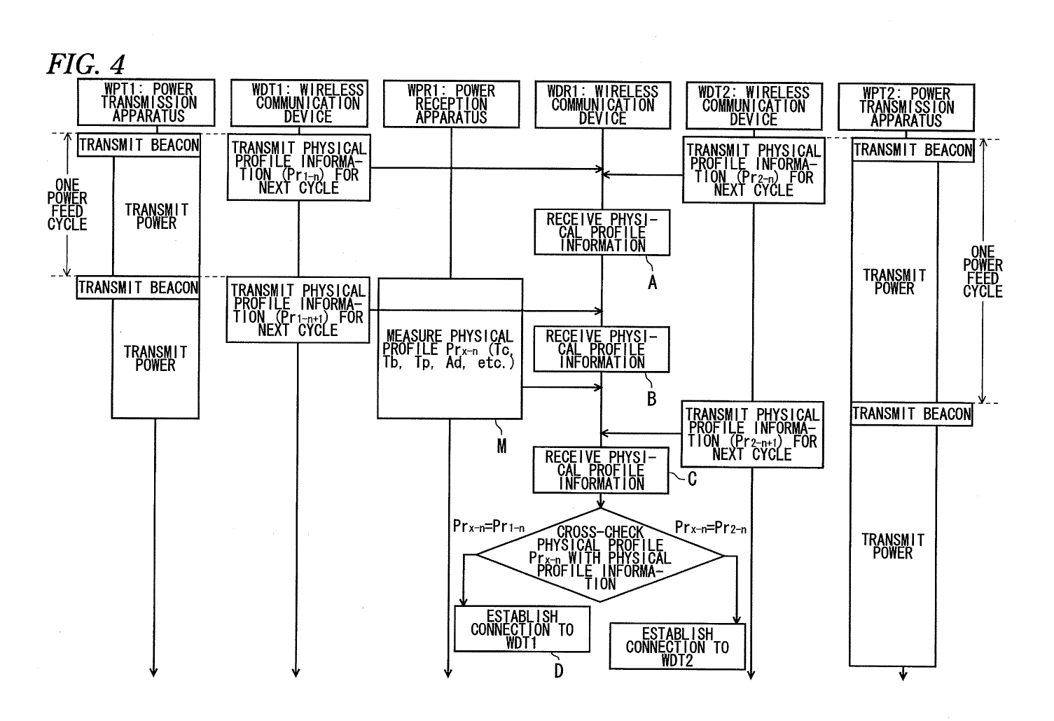

FIG. 4 exemplarily shows a flow chart of the first embodiment. In the example 1, a power reception apparatus WPR1 exists in a wireless power transfer area 1, and the power reception apparatus WPR1 (corresponding to the power reception apparatus 200) receives power from a power transmission apparatus WPT1 (corresponding to the power transmission apparatus 100).

Wireless communication devices WDR1 (corresponding to the communication portion 201) and WDR2 (not shown) acquire physical profiles for a next cycle determined in the power transmission apparatuses WPT1, WPT2, respectively (step A). The acquired physical profiles are broadcast from the wireless communication devices WDT1, WDT2. The physical profile information is transmitted in sync with power burst transmission of the power transmission apparatuses WDT1, WDT2 in each power feed cycle or at intervals of the predetermined number of power feed cycles (steps B and C). The physical profiles are calculated according to predetermined rules, and then broadcast. As to the method of calculating the physical profiles, the physical profiles may be calculated according to a certain algorism or may be calculated based on a table, etc. which is held in the transmission and reception sides in advance. The profile received from each wireless communication device WDT1, WDT2 by the wireless communication device WDR1 is transmitted as physical profile information Pr₁₋ₙ, Pr₂₋ₙ to a controller (corresponding to the controller 202) of the power reception apparatus WPR1. The power reception apparatus WPR1 measures received power, for example, by the power reception detection circuit 208, and obtains a physical profile, for example, through the physical profile measuring circuit 209 (Step M). It is assumed here that the power reception apparatus WPR1 exists only in the wireless power transfer area 1 but is located out of a wireless power transfer area 2. Therefore, the power received by the power reception apparatus WPR1 comes from power transmitted from the power transmission apparatus WPT1. The power reception apparatus WPR1 measures power burst, and cross-checks a physical profile Prₓ₋ₙ, which is a result of the measurement, with the received physical profile information. As a result of the cross-checking, in this example, the physical profile Prₓ₋ₙ coincides with physical profile information Pr₁₋ₙ. Therefore, the wireless communication device WDR1 establishes connection to the wireless communication device WDT1 and starts wireless power transfer after authentication, etc. (Step D).

### EXAMPLE 2

In the example 1, in order to make a physical profile unique to each of the plural power transmission apparatuses, respective profile values may be unique fixed values. Alternatively, the respective profile values may be values fluctuating (or hopping) based on a predetermined algorism or values fluctuating at random within a predetermined range, like Bluetooth (registered trademark) Standards.

### Second Embodiment

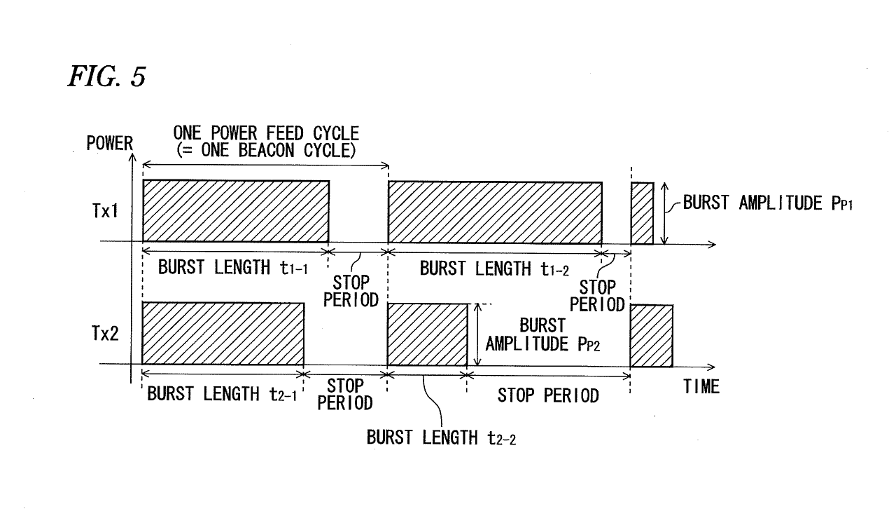

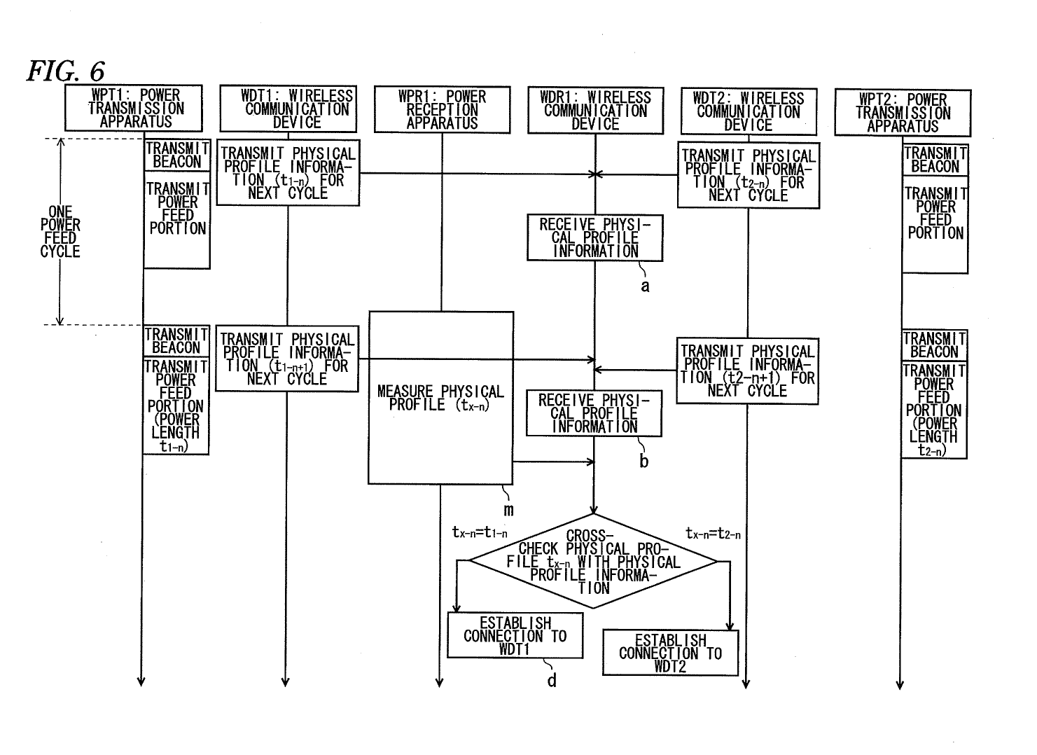

A second embodiment will be described with reference to FIGS. 5 and 6. Description about parts common to those in the first embodiment will be omitted.

### EXAMPLE 3

FIG. 5 shows another example of a power transmission pattern, which is different from the example 1, in wireless power transfer. Power transmission in this system is not continuous. A power transmission period is determined so that requested power can be supplied in response to a request from a power reception apparatus. If there is no request from the power reception apparatus, power for a fixed period is transmitted as beacon. In addition, it is assumed that a stop period in which each power transmission apparatus stops to transmit power must be present in a power feed cycle. In FIG. 5, (the stop period length)=(the beacon cycle)−(the power burst length), and (the burst amplitude)=(the power feed portion amplitude)=(the beacon amplitude). A rising edge of power is treated as a start portion of one cycle.

FIG. 6 exemplarily shows a flow chart of the second embodiment. In the third example, the power reception apparatus WPR1 exists in the wireless power transfer area 1, and the power reception apparatus WPR1 receives power from the power transmission apparatus WPT1.

The wireless communication devices WDR1, WDR2 acquire physical profiles, such as burst lengths to be transmitted in a next cycle, which are determined in the power transmission apparatuses WDT1, WDT2, respectively (step a). The acquired physical profiles are broadcast from the wireless communication devices WDT1 and WDT2. The physical profile information is transmitted in sync with power burst transmission of the power transmission apparatuses WDT1, WDT2 in each power feed cycle or at intervals of the predetermined number of power feed cycles (step b). The physical profiles are calculated according to predetermined rules, and then broadcast. As to the method of calculating the physical profiles, the physical profiles may be calculated according to a certain algorism or may be calculated based on a table, etc., which is held on the transmission and reception sides in advance. The physical profile received from each wireless communication device WDT1, WDT2 is transmitted as physical profile information to the controller of the power reception apparatus WPR1. In the example 3, it is assumed that profiles used for cross-checking are burst lengths. However, it should be noted that other profile values than the burst lengths may be used. Upon start of the next power feed cycle, the power reception apparatus WPR1 measures a burst length of received power (step m). It is assumed that the power reception apparatus WPR1 exists only in the wireless power transfer area 1 but is located out of the wireless power transfer area 2. Therefore, the received power comes from power transmitted from the power transmission apparatus WPT1. The power reception apparatus WPR1 cross-checks a measured result tₓ₋ₙ (n^{th} cycle) with information t₁₋ₙ and t₂₋ₙ of the received burst lengths. As a result of the cross-checking, in the example 3, tₓ₋ₙ coincides with t₁₋ₙ. Therefore, the wireless communication device WDR1 establishes connection to the wireless communication device WDT1 (Step d) and starts wireless power transfer after authentication, etc.

### EXAMPLE 4

In the example 3, there may be a case where a power transmission period in one power transmission apparatus is equal to that in another adjacent power transmission apparatus. For example, there is particularly a case where only beacon is transmitted without power transmission. In this case, burst length information transmitted from one power transmission apparatus may be the same as that transmitted from another power transmission apparatus, so that it may be difficult to distinguish the power transmission apparatuses. In order to deal with this situation, a power transmission period of beacon or the like may be prolonged. The prolonged periods may be determined at random, may be set at fixed values determined in advance or at values calculated based on a predetermined algorism so that the burst length information of the power transmission apparatuses are different from each other.

### Third Embodiment

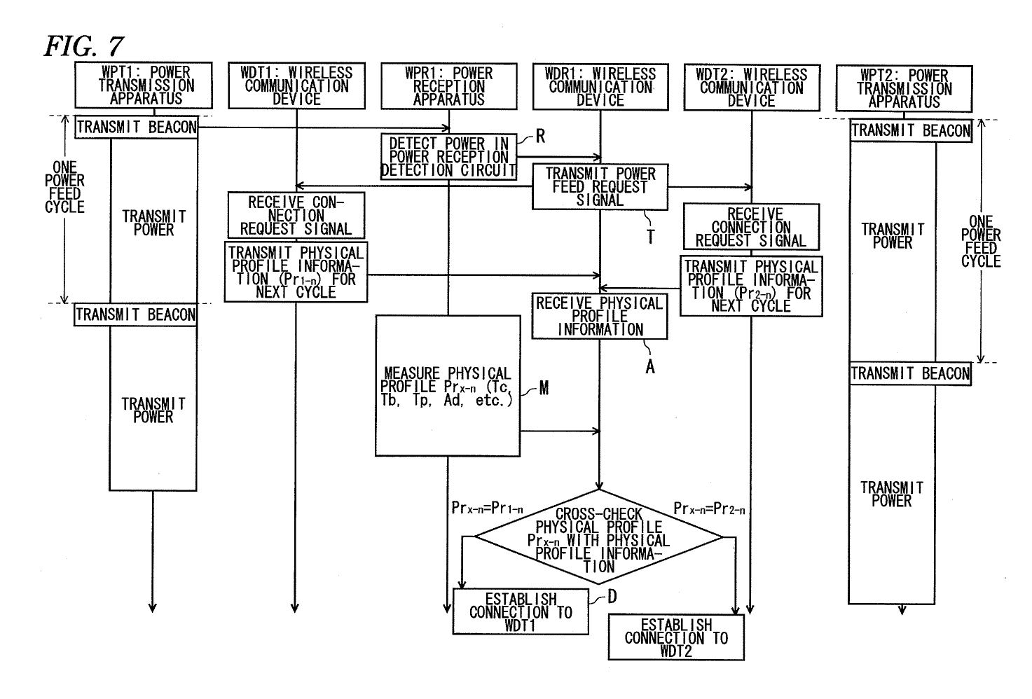

A third embodiment will be described with reference to FIG. 7. Description about parts common to those in the first or second embodiment will be omitted.

### EXAMPLE 5

In the examples 1 and 3, the physical profile information is transmitted in sync with the beacon of the transmitted power burst. However, there may be a case where if there is no power reception apparatus, it is unnecessary to transmit the profile information. In consideration of such a case, control is performed in such a manner that a request to send out physical profile information is issued from a power reception apparatus when the power reception apparatus, which requires power to be supplied thereto, exists. The example 5 will be described on the assumption that the pattern of power burst shown in FIG. 3 is used. However, control may be performed in a similar flow even if the pattern of power burst shown in FIG. 5 is used.

FIG. 7 exemplarily shows a flow chart of the third embodiment. In the example 5, the power reception apparatus WPR1 exists in the wireless power transfer area 1, and that the power reception apparatus WPR1 receives power from the power transmission apparatus WPT1. First, power from the power transmission apparatus WPT1 is detected by the power reception detection circuit of the power reception apparatus WPR1 (step R). When the power reception apparatus WPR1 requires power to be supplied thereto, the wireless communication device WDR1 provided in the power reception apparatus WPR1 attempts to communicate with the wireless communication device provided in the power transmission apparatus WPT1 in order to transmit a power feed request signal (step T). The wireless communication device WDR1 exits in both a wireless communication area 1 and a wireless communication area 2. Therefore, a connection request signal transmitted by the wireless communication device WDR1 can be received by both the wireless communication device WDT1 and the wireless communication device WDT2 provided in the power transmission apparatus WPT2. The wireless communication devices WDR1, WDR2 respectively corresponding to the wireless communication devices WDT1, WDT2, which have received the connection request signal, acquire physical profiles for a next cycle, which is determined in the power transmission apparatuses WDT1, WDT2, respectively (step A). The acquired physical profiles are broadcast as parts of information required for connection (wireless communication beacon information), from the wireless communication devices, respectively. Here, the profiles are calculated according to predetermined rules, and then broadcast. As to the method of calculating the profiles, the profiles may be calculated according to a certain algorism or may be calculated based on a table, etc., which is held on the transmission and reception sides in advance. In this manner, physical profile information is transmitted only when there is a connection request from a power reception apparatus, so that traffic of the power transmission apparatuses can be improved efficiently. The profile received from each wireless communication device WDT1, WDT2 by the wireless communication device WDR1 is transmitted as physical profile information to the controller of the power reception apparatus WPR1. The power reception apparatus WPR1 measures received power and acquires a physical profile (step M). It is assumed that the power reception apparatus WPR1 exists only in the wireless power transfer area 1 but is located out of the wireless power transfer area 2. Therefore, the received power comes from power transmitted from the power transmission apparatus WPT1. The power reception apparatus WPR1 measures power burst, and cross-checks a physical profile Prₓ₋ₙ, which is a result of the measurement, with the received physical profile information. As a result of the cross-checking, in the example 5, the physical profile Prₓ₋ₙ coincides with the physical profile information Pr₁₋ₙ. Therefore, the wireless communication device WDR1 establishes connection to the wireless communication device WDT1 (step D) and starts wireless power transfer after authentication, etc.

According to the above-described embodiments, a physical profile acquired by a power reception apparatus is cross-checked with physical profile information acquired from wireless communication devices in the process of selecting one of the wireless communication devices as a connection destination. Thus, connection is established after determination as to matching between the wireless communication devices and the power reception apparatus is made. Accordingly, the power reception apparatus can establish connection to a targeted wireless communication device so that time required for starting authentication and power feeding can be shortened.

That is, in the above-described embodiments, in order to distinguish wireless transmission devices in a power transfer area, a profile of electric power transmitted in wireless power transfer is added to information to be transmitted by the wireless communication devices for initiation of connection. Thus, even if a power reception apparatus is located in a plurality of wireless communication areas, the power reception apparatus can determine which wireless communication device the power reception apparatus has to communicate at a time of start of connection. Specifically, power received in a wireless power transfer area is measured, and a physical profile is created. The created physical profile is cross-checked with information of physical profiles received from a plurality of wireless communication devices. Of them, a wireless communication device whose physical profile information coincides with the created physical profile is identified as a targeted wireless communication device. Thus, reconnection caused by erroneous selection of a connection destination can be avoided so that time required for starting wireless power transfer can be shortened.

### Supplemental Description of Embodiments

(1) A power transfer system includes a power transmission apparatus (WPT1) and a power reception apparatus (WPR1). The power transmission apparatus (WPT1) has a power transmission module, and a first wireless communication device (WDT1) configured to transmit physical profile information of the power transmission apparatus (WPT1). The power reception apparatus (WPR1) has a power reception module, a second wireless communication device (WDR1) configured to receive the physical profile information, and a controller. Wireless power transfer is conducted between the power transmission module and the power reception module. The controller is configured to cross-check a physical profile of a power signal of the wireless power transfer received by the power reception module with the physical profile information and identify the first wireless communication device (WDT1) based on a result of the cross-check.
(2) In the power transfer system of (1), in the power transfer, a first period in which the power transmission module transmits the power signal and a second period in which the power transmission module stops the transmitting of the power signal may be repeated. The physical profile may include at least one of a time length of the first period, a time length of the second period, and a ratio between the time length of the first period and the time length of the second period.
(3) In the power transfer system of (1), the physical profile may include a frequency of the power signal.
(4) In the power transfer system of (2), the power signal may include a first amplitude and a second amplitude which are different from each other. The physical profile may include at least one of a time length of a third period in which the power signal takes the first amplitude, a fourth period in which the power signal takes the second amplitude, and a ratio between the third period and the fourth period.
(5) In the power transfer system of (1), the physical profile may include a fixed value unique to the power transmission apparatus (WPT1), a value fluctuating based on a predetermined algorism, and a value fluctuating at random within a predetermined range.

The invention is not limited to the above-described embodiments, but may be variously modified in a practical stage without departing from the gist of the invention.

In addition, a plurality of constituent elements described in the embodiments may be combined suitably to form various modifications. For example, some constituent elements may be removed from all the constituent elements described in the embodiments. Further, constituent elements of different embodiments may be combined suitably.

What is claimed is:

1. A power transfer system comprising:
a power transmission apparatus including
a power transmission module, and
a first wireless communication device configured to transmit physical profile information of the power transmission apparatus; and
a power reception apparatus including
a power reception module, wherein wireless power transfer is conducted between the power transmission module and the power reception module,
a second wireless communication device configured to receive the physical profile information, and
a controller configured to cross-check a physical profile of a power signal of the wireless power transfer received by the power reception module with the physical profile information and identify the first wireless communication device based on a result of the cross-check.

2. The power transfer system according to claim 1, wherein
in the power transfer, a first period in which the power transmission module transmits the power signal and a second period in which the power transmission module stops the transmitting of the power signal are repeated, and
the physical profile includes at least one of a time length of the first period, a time length of the second period, and a ratio between the time length of the first period and the time length of the second period.

3. The power transfer system according to claim 1, wherein the physical profile includes a frequency of the power signal.

4. The power transfer system according to claim 1, wherein
the power signal includes a first amplitude and a second amplitude which are different from each other, and
the physical profile includes at least one of a time length of a third period in which the power signal takes the first amplitude, a fourth period in which the power signal takes the second amplitude, and a ratio between the third period and the fourth period.

5. The power transfer system according to claim 1, wherein the physical profile includes a fixed value unique to the power transmission apparatus, a value fluctuating based on a predetermined algorism, and a value fluctuating at random within a predetermined range.

6. A power transmission apparatus in a power transfer system, wherein
the power transfer system includes
the power transmission apparatus, and
the power reception apparatus having
a power reception module,
a second wireless communication device, and
a controller,
the power transmission apparatus comprising:
a power transmission module, wherein wireless power transfer is conducted between the power transmission module and the power reception module; and
a first wireless communication device configured to transmit physical profile information of the power transmission apparatus so that the second communication device receives the physical profile information and the controller cross-checks a physical profile of a power signal of the wireless power transfer received by the power reception module with the physical profile information and identifies the first wireless communication device based on a result of the cross-check.

7. A power reception apparatus in a power transfer system, wherein
the power transfer system includes
a power transmission apparatus having
a power transmission module, and
a first wireless communication device configured to transmit physical profile information of the power transmission apparatus, and
the power reception apparatus,
the power reception apparatus comprising:
a power reception module, wherein wireless power transfer is conducted between the power transmission module and the power reception module;
a second wireless communication device configured to receive the physical profile information, and
a controller configured to cross-check a physical profile of a power signal of the wireless power transfer received by the power reception module with the physical profile information and identify the first wireless communication device based on a result of the cross-check.
